(19) United States
(12) Patent Application Publication
(10) Pub. No.: US 2024/0160947 A1
(43) Pub. Date: May 16, 2024

(54) LEARNING DEVICE, LEARNING METHOD, AND STORAGE MEDIUM

(71) Applicant: NEC Corporation, Tokyo (JP)

(72) Inventors: Toshinori Araki, Tokyo (JP); Kazuya Kakizaki, Tokyo (JP); Inderjeet Singh, Tokyo (JP)

(73) Assignee: NEC Corporation, Tokyo (JP)

(21) Appl. No.: 18/387,908

(22) Filed: Nov. 8, 2023

(30) Foreign Application Priority Data
Nov. 10, 2022 (JP) 2022-180596

(51) Int. Cl. G06N 3/094

(52) U.S. Cl. CPC G06N 3/094

(57) ABSTRACT

A learning device for a neural network uses a base data group, which is a group including a plurality of data, to update a parameter value of the partial network and a parameter value of the second normalization layer, and uses an adversarial example determined to induce an error in estimation using the neural network, among adversarial examples included in an adversarial data group, which is a group including a plurality of adversarial examples with respect to the data included in the base data group, to update the parameter value of the partial network and a parameter value of the first normalization layer. The neural network includes a partial network, a first normalization layer normalizing data input to the first normalization layer itself, and a second normalization layer normalizing data input to the second normalization layer itself.

This application is based upon and claims the benefit of priority from Japanese patent application No. 2022-180596, filed on Nov. 10, 2022, the disclosure of which is incorporated herein in its entirety by reference.

### TECHNICAL FIELD

The present disclosure relates to a learning device, a learning method, and a storage medium.

### BACKGROUND ART

Adversarial examples (AX) may be used to train neural networks (see, for example, Japanese Unexamined Patent Application Publication No. 2021-005138).

### SUMMARY

When adversarial examples are used to train neural networks, the accuracy of the adversarial examples should be taken into account.

An example of an object of the present disclosure is to provide a learning device, a learning method, and a program that can solve the above-mentioned problems.

According to the first example aspect of the present disclosure, a learning device includes a data acquisition means that acquires a base data group, which is a group including a plurality of data; an adversarial example acquisition means that acquires an adversarial data group, which is a group including a plurality of adversarial examples with respect to the data included in the base data group acquired by the data acquisition means; an error induction determination means that determines, when data is input to a neural network that includes a partial network, a first normalization layer, and a second normalization layer, the first normalization layer normalizing data input to the first normalization layer itself using a first average value and a first variance value and the second normalization layer normalizing data input to the second normalization layer itself using a second average value and a second variance value, whether that data induces an error in estimation using the neural network; and a parameter updating means that uses the base data group to update a parameter value of the partial network and a parameter value of the second normalization layer, and uses the adversarial example determined to induce an error in estimation using the neural network, among the adversarial examples included in the adversarial data group, to update the parameter value of the partial network and a parameter value of the first normalization layer.

According to the second example aspect of the disclosure, a learning method includes a computer acquiring a base data group, which is a group including a plurality of data; acquiring an adversarial data group, which is a group including a plurality of adversarial examples with respect to the data included in the acquired base data group; determining, when data is input to a neural network that includes a partial network, a first normalization layer, and a second normalization layer, the first normalization layer normalizing data input to the first normalization layer itself using a first average value and a first variance value and the second normalization layer normalizing data input to the second normalization layer itself using a second average value and a second variance value, whether that data induces an error in estimation using the neural network; and using the base data group to update a parameter value of the partial network and a parameter value of the second normalization layer, and using the adversarial example determined to induce an error in estimation using the neural network, among the adversarial examples included in the adversarial data group, to update the parameter value of the partial network and a parameter value of the first normalization layer.

According to the third example aspect of the disclosure, a program is a program for causing a computer to acquire a base data group, which is a group including a plurality of data; acquire an adversarial data group, which is a group including a plurality of adversarial examples with respect to the data included in the acquired base data group; determine, when data is input to a neural network that includes a partial network, a first normalization layer, and a second normalization layer, the first normalization layer normalizing data input to the first normalization layer itself using a first average value and a first variance value and the second normalization layer normalizing data input to the second normalization layer itself using a second average value and a second variance value, whether that data induces an error in estimation using the neural network; and use the base data group to update a parameter value of the partial network and a parameter value of the second normalization layer, and use the adversarial example determined to induce an error in estimation using the neural network, among the adversarial examples included in the adversarial data group, to update the parameter value of the partial network and a parameter value of the first normalization layer.

According to the present disclosure, when adversarial examples are used to train neural networks, the accuracy of the adversarial examples can be taken into account.

### BRIEF DESCRIPTION OF THE DRAWINGS

FIG. 1 is a diagram showing an example of the configuration of the learning device according to the first example embodiment.

FIG. 2 is a diagram showing an example of a neural network stored by the model storage portion according to the first example embodiment.

FIG. 3 is a diagram showing an example of the procedure in which the processing portion according to the first example embodiment learns a neural network.

FIG. 4 is a diagram showing an example of the procedure in which the processing portion according to the first example embodiment collects data for updating parameter values based on adversarial examples.

FIG. 5 is a diagram showing an example of the procedure in which the learning device collects data for updating parameter values based on adversarial examples when the neural network according to the first example embodiment is configured as categorical AI.

FIG. 6 is a diagram showing an example of the procedure in which the learning device collects data for updating parameter values based on adversarial examples when the neural network of the first example embodiment is configured as feature-extraction AI.

FIG. 7 is a diagram showing an example of the configuration of the learning device according to the second example embodiment.

FIG. 8 is a diagram showing an example of the procedure in which the processing portion according to the second example embodiment learns a neural network.

FIG. 9 is a diagram showing an example of the procedure in which the processing portion according to the second example embodiment collects data for updating parameter values based on adversarial examples.

FIG. 10 is a diagram showing an example of the configuration of the estimating device according to the third example embodiment.

FIG. 11 is a diagram showing an example of a neural network stored by the model storage portion according to the third example embodiment.

FIG. 12 is a diagram showing an example of the configuration of the learning device according to the fourth example embodiment.

FIG. 13 is a diagram showing an example of the processing procedure in the learning method according to the fifth example embodiment.

FIG. 14 is a schematic block diagram showing a computer according to at least one example embodiment.

### EXAMPLE EMBODIMENT

The following is a description of example embodiments of the disclosure, but the following example embodiments are not limiting to the claimed disclosure. Not all of the combinations of features described in the example embodiments are essential to the solution of the disclosure.

### First Example Embodiment

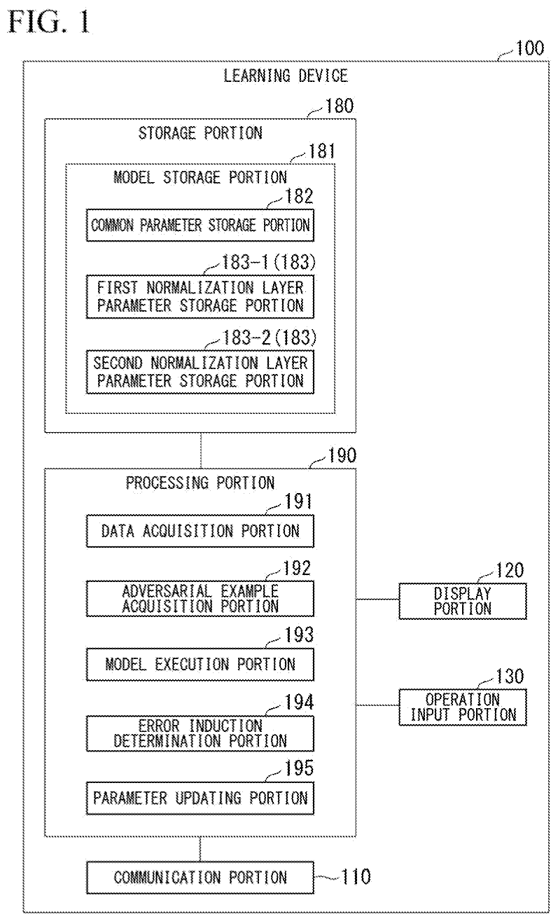

FIG. 1 is a diagram showing an example of the configuration of the learning device according to the first example embodiment. In the configuration shown in FIG. 1, a learning device 100 includes a communication portion 110, a display portion 120, an operation input portion 130, a storage portion 180, and a processing portion 190. The storage portion 180 includes a model storage portion 181. The model storage portion 181 includes a common parameter storage portion 182, a first normalization layer parameter storage portion 183-1, and a second normalization layer parameter storage portion 183-2. The processing portion 190 includes a data acquisition portion 191, an adversarial example acquisition portion 192, a model execution portion 193, an error induction determination portion 194, a parameter updating portion 195.

The learning device 100 learns neural networks. The learning device 100 may be configured using a computer, such as a personal computer (PC) or a workstation (WS).

The communication portion 110 communicates with other devices. For example, the communication portion 110 may receive data for neural network training from other devices. Further, for example, the communication portion 110 may receive from another device data in which the data intended for input to the neural network and the class to which the data is classified are linked.

The display portion 120 includes a display screen, such as a liquid crystal panel or light emitting diode (LED) panel, for example, and displays various images. For example, the display portion 120 may display information about the learning of the neural network, such as the progress of the neural network learning.

The operation input portion 130 is constituted by input devices such as a keyboard and mouse, for example, and receives user operations. For example, the operation input portion 130 may receive user operations for learning a neural network, such as input operations for the termination conditions of learning a neural network.

The storage portion 180 stores various data. The storage portion 180 is configured using the storage device provided by the learning device 100.

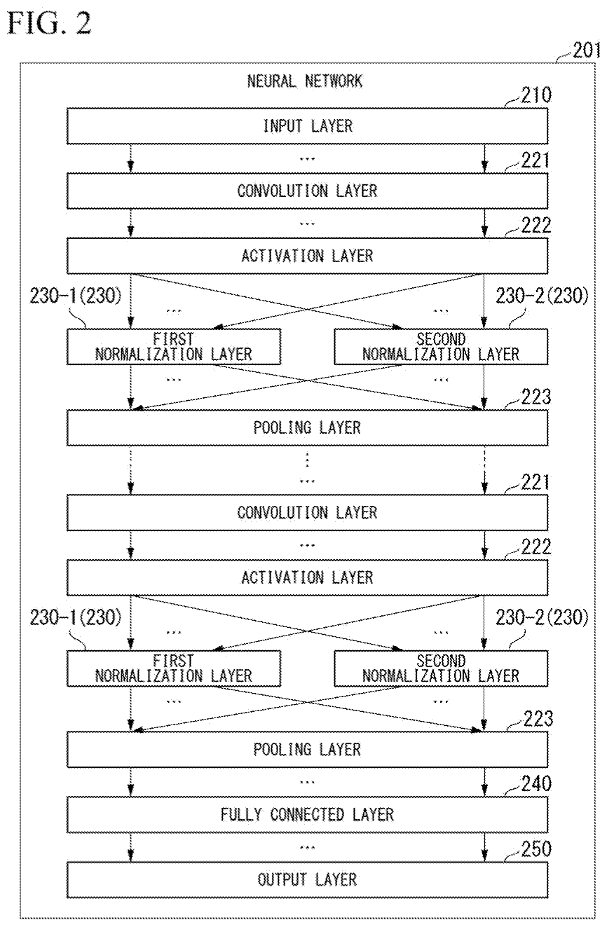

The model storage portion 181 stores neural networks as machine learning models. FIG. 2 is a diagram showing an example of a neural network stored by the model storage portion 181. The neural network 201 shown in FIG. 2 is configured as a type of convolutional neural network (CNN) and includes an input layer 210, a convolution layer 221, an activation layer 222, a pooling layer 223, a first normalization layer 230-1, a second normalization layer 230-2, a fully connected layer 240, and an output layer 250.

The first normalization layer 230-1 and the second normalization layer 230-2 are also collectively denoted as normalization layers 230.

In the example in FIG. 2, one or more combinations of these layers are arranged in order from upstream in the data flow: the input layer 210 is followed by the convolution layer 221, the activation layer 222, and the pooling layer 223 in that order, and downstream of these layers are the fully connected layer 240 and the output layer 250.

The first normalization layer 230-1 and the second normalization layer 230-2 are placed in parallel between the activation layer 222 and the pooling layer 223 in each combination of the convolution layer 221, the activation layer 222, and the pooling layer 223.

The number of channels in the neural network 201 is not limited to a specific number.

The data for all channels from the activation layer 222 is input to both of the first normalization layer 230-1 to the second normalization layer 230-2. Alternatively, the activation layer 222 may selectively output data to either one of the first normalization layer 230-1 and the second normalization layer 230-2.

With the data output by the first normalization layer 230-1 and the data output by the second normalization layer 230-2, the same channel data is combined and input to the pooling layer 223. For example, the sum of the data output by the first normalization layer 230-1 and the data output by the second normalization layer 230-2 may be input to the pooling layer 223. Alternatively, data that is an average of the data output by the first normalization layer 230-1 and the data output by the second normalization layer 230-2 may be input to the pooling layer 223.

Alternatively, if only one of the first normalization layer 230-1 and the second normalization layer 230-2 obtains data from the activation layer 222, only the normalization layer 230 that obtained the data may output data to the pooling layer 223.

The parts of the neural network 201 other than the first normalization layer 230-1 and the second normalization layer 230-2 are also referred to as common parts or partial network. In the case of the example in FIG. 2, the combination of the input layer 210, the convolution layer 221, the activation layer 222, the pooling layer 223, the fully connected layer 240, and the output layer 250 are examples of common parts.

The input layer 210 receives input data to the neural network 201.

The convolution layer 221 performs convolution operations on the data input to the convolution layer 221 itself. The convolution layer 221 may further perform padding to adjust the data size.

The activation layer 222 applies an activation function to the data input to the activation layer 222 itself. The activation function used by the activation layer 222 is not limited to a specific function. For example, a Normalized Linear Function (ReLU) may be used as the activation function, but is not limited thereto.

The pooling layer 223 performs pooling on data input to the pooling layer 223 itself.

The first normalization layer 230-1 normalizes the data input to the first normalization layer 230-1 itself. The normalization here is the same as in Batch Normalization, where the first normalization layer 230-1 transforms the data so that the average values and variance values of the data included in one group are the predetermined values.

For example, if the average value of one group of data is set to 0 and the variance value is set to 1, the first normalization layer 230-1 calculates the average and variance values of the group of data being normalized, subtracts the average value from each data and divides the value after subtraction by the variance value.

The average value after normalization by the first normalization layer 230-1 is not limited to 0, and the variance value is not limited to 1. For example, assuming a is a real number and β a positive real number, the first normalization layer 230-1 may perform normalization such that the group's average value becomes a and the variance value is β. These values of α and β may also be subject to learning. The values of α and β may be set by learning for each first normalization layer 230-1.

The average value of the group targeted by the first normalization layer 230-1 is also referred to as the first average value. The variance value of the group targeted by the first normalization layer 230-1 is also referred to as the first variance value. The first average value and first variance value correspond to examples of parameter values of the first normalization layer 230-1. The parameter indicating the first average value is also referred to as the first average. The parameter indicating the first variance value is also referred to as the first variance.

When data for multiple channels is input to the first normalization layer 230-1, the first normalization layer 230-1 may perform data normalization for all data in a single group and across multiple channels. Alternatively, the first normalization layer 230-1 may perform data normalization for each channel.

The second normalization layer 230-2 normalizes the data input to the second normalization layer 230-2 itself. The normalization process performed by the second normalization layer 230-2 is the same as the normalization process performed by the first normalization layer 230-1, described above.

The average value of the group targeted by the second normalization layer 230-2 is also referred to as the second average value. The variance value of the group targeted by the second normalization layer 230-2 is also referred to as the second variance value. The second average value and second variance value correspond to examples of parameter values of the second normalization layer 230-2. The parameter indicating the second average value is also referred to as the second average. The parameter indicating the second variance value is also referred to as the second variance.

The first normalization layer 230-1 and the second normalization layer 230-2 have different data for learning parameter values, as described below.

The fully connected layer 240 converts the data input to the fully connected layer 240 itself into data with the output data number of the neural network 201.

The output layer 250 outputs the output data of the neural network 201. For example, the output layer 250 may apply an activation function, such as a softmax function, to the data from the fully connected layer 240.

Alternatively, the fully connected layer 240 may generate output data for the neural network 201, and the output layer 250 may output the data from the fully connected layer 240 as is. In this case, the fully connected layer 240 may also function as the output layer 250, outputting data directly to the outside of the neural network 201.

However, the configuration of the machine learning model stored by the model storage portion 181 is not limited to a specific configuration.

For example, when the model storage portion 181 stores a convolutional neural network as a machine learning model, the configuration and number of layers of the convolutional neural network can be of various configurations and numbers. For example, the configuration of the machine learning model stored by the model storage portion 181 may be a combination of the convolution layer 221, activation layer 222, and pooling layer 223 included in the neural network 201 in the example in FIG. 2, without the activation layer 222.

The location where the combination of the first normalization layer 230-1 and the second normalization layer 230-2 is provided is not limited to a specific location. For example, among the combinations of the convolution layer 221, the activation layer 222, and the pooling layer 223, combinations from the first normalization layer 230-1 to the second normalization layer 230-2 may be provided for only a subset of these combinations.

The configuration of the machine learning model stored by the model storage portion 181 may consist of a convolutional neural network with batch normalization layers, with the number of batch normalization layers being two and arranged in parallel.

However, the machine learning model stored by the model storage portion 181 is not limited to a convolutional neural network, and it can encompass various neural networks where normalization by the first normalization layer 230-1 and the second normalization layer 230-2 can be applied.

The method of implementing the neural network subject to learning by the learning device 100 is not limited to the method in which the model storage portion 181 stores the neural network. For example, the neural network subject to learning by the learning device 100 may be implemented in hardware, such as through the use of an Application Specific Integrated Circuit (ASIC) or Field-Programmable Gate Array (FPGA).

The neural network subject to learning by the learning device 100 may be configured as part of the learning device 100, or it may be external to the learning device 100.

The common parameter storage portion 182 stores parameter values of the common parts. The common parameter storage portion 182 stores the values of various parameters to be learned, such as, for example, the filter for the convolution operation in the convolution layer and the parameters of the activation function in the activation layer.

The parameter values of the common parts are also referred to as common parameter values.

The first normalization layer parameter storage portion 183-1 stores, for each first normalization layer 230-1, the parameter values for that first normalization layer 230-1. The first normalization layer parameter storage portion 183-1 stores the values of various parameters subject to learning, such as the first average and first variance, for example.

The second normalization layer parameter storage portion 183-2 stores, for each second normalization layer 230-2, the parameter values for that second normalization layer 230-2. The second normalization layer parameter storage portion 183-2 stores the values of various parameters subject to learning, such as the second average and second variance, for example.

The processing portion 190 controls the various parts of the learning device 100 and performs various processes. The functions of the processing portion 190 are performed, for example, by the central processing unit (CPU) provided in the learning device 100, which reads and executes a program from the storage portion 180.

The data acquisition portion 191 acquires a group that contains a plurality of data that are subject to input to the neural network 201 and to which information indicating the class of the correct answer in the class classification is associated. The data acquisition portion 191 corresponds to an example of a data acquisition means.

The data acquired by the data acquisition portion 191, which is the subject of input to the neural network 201, is also referred to as the base data. A group of base data is also referred to as a base data group. The number of base data groups acquired by the data acquisition portion 191 can be one or more, and is not limited to a specific number. When the data acquisition portion 191 acquires multiple groups of base data, the number of base data in each group may be the same or different.

The data acquisition portion 191 may acquire the base data from other devices via the communication portion 110.

The data acquisition portion 191 may also acquire base data from other devices in the form of base data groups. Alternatively, the data acquisition portion 191 may acquire base data from other devices and group them together into base data groups.

The adversarial example acquisition portion 192 acquires an adversarial data group, which is a group containing multiple adversarial examples for data included in the base data group acquired by the data acquisition portion 191. Here, an adversarial example for a given data is an adversarial example in which an adversarial perturbation is added to the data.

The adversarial example acquisition portion 192 corresponds to an example of an adversarial example acquisition means.

The adversarial example acquisition portion 192 may apply the adversarial example generation method to the base data acquired by the data acquisition portion 191 to generate an adversarial example. Alternatively, the adversarial example acquisition portion 192 may acquire adversarial examples from a device generating adversarial examples via the communication portion 110.

The number of adversarial examples in an adversarial data group may be the same as or different from the number of base data in the base data group.

When the adversarial example acquisition portion 192 generates adversarial examples from the base data, it may generate the adversarial examples one by one from all the base data in one base data group and then consolidate them into one adversarial data group. Alternatively, the adversarial example acquisition portion 192 may generate one adversarial example from some of the base data included in one base data group and consolidate them into one adversarial data group. Alternatively, the adversarial example acquisition portion 192 may generate adversarial examples from the base data contained in each of the plurality of base data groups and consolidate them into one adversarial data group.

The adversarial example acquisition portion 192 may generate multiple adversarial examples from a single base data.

The model execution portion 193 executes the machine learning model stored by the model storage portion 181. Specifically, the model execution portion 193 inputs data to the neural network 201 and calculates the output data of the neural network 201. The calculation of output data by the neural network 201 is also referred to as estimation using neural network 201, or simply estimation.

The neural network 201 may output an estimate of the class into which the input data is classified. In this case, the neural network is also referred to as categorical AI.

Alternatively, the neural network 201 may output features of the input data. The neural network in this case is also referred to as feature-extraction AI.

The error induction determination portion 194 determines whether the input data to the neural network 201 induces errors in estimation using the neural network 201. The error induction determination portion 194 corresponds to an example of an error induction determination means.

When the neural network 201 is configured as categorical AI, the error induction determination portion 194, when the class estimation result output by the neural network 201 is different from the correct class associated with the input data to the neural network 201, may determine that the input data induces an error in the estimation using the neural network 201.

Alternatively, if the neural network 201 is configured as categorical AI, the error induction determination portion 194, when the class estimation results output by the neural network 201 indicate the target class of the adversarial example, which is the input data, may determine that the input data induces an error in the estimation using the neural network 201.

Here, if an adversarial example is intended to be misclassified into a certain class, that class (the class to which it is misclassified) is also referred to as the target class. In addition to data indicating the correct class, data indicating the target class may also be associated with the adversarial example.

When the neural network 201 is configured as feature-extraction AI, the error induction determination portion 194 may calculate the similarity between the feature output by the neural network 201 and the feature associated with the target class of the adversarial example, which is the input data to the neural network 201. If the calculated similarity is equal to or greater than a predetermined threshold, the error induction determination portion 194 may determine that the input data induces an error in estimation using the neural network 201.

The similarity index used by the error induction determination portion 194 is not limited to a specific one. The error induction determination portion 194 may calculate an index value, such as cosine similarity, as an indicator of the similarity of the two features, such that the larger the index value, the more similar the two features are. Alternatively, the error induction determination portion 194 may calculate an index value, such as the distance between two features in a feature space, that indicates that the smaller the index value, the more similar the two features are.

A feature associated with a target class may be a feature of a single piece of data belonging to that target class. Alternatively, the feature associated with a target class may be a feature that is the average of the features of multiple data belonging to that target class.

The parameter updating portion 195 learns the neural network 201 and updates the parameter values of the neural network 201. The parameter updating portion 195 updates the parameter values of the partial network and the parameter values of the second normalization layer 230-2 using the base data group. In addition, the parameter updating portion 195 uses the adversarial example which the error induction determination portion 194 determined to induce an error in estimation using the neural network 201, among the adversarial examples included in the adversarial data group, to update the parameter value of the partial network and the parameter value of the first normalization layer 230-1. Similar to updating parameters in mini-batch learning, the parameter updating portion 195 may update parameter values using the average value of the plurality of input data in each part of the neural network 201 for multiple input data.

The parameter updating portion 195 corresponds to an example of a parameter updating means.

As mentioned above, data may be input to both the first normalization layer 230-1 and the second normalization layer 230-2. Alternatively, the data may be selectively input to either one of the first normalization layer 230-1 and the second normalization layer 230-2.

When each data of the base data group (base data) is input to the neural network 201, the data of all channels from the activation layer 222, which outputs data to the first normalization layer 230-1 and the second normalization layer 230-2, may be input to both the first normalization layer 230-1 and the second normalization layer 230-2, or only to the second normalization layer 230-2 of these two.

When each data of a hostile data group (adversarial example) is input to the neural network 201, the data of all channels from the activation layer 222, which outputs the data to the first normalization layer 230-1 and the second normalization layer 230-2, may be input to both the first normalization layer 230-1 and the second normalization layer 230-2, or only to the first normalization layer 230-1 of these two.

The method by which the parameter updating portion 195 updates parameter values is not limited to a specific method. The parameter updating portion 195 may update parameter values using known methods applicable to mini-batch learning, such as error back-propagation.

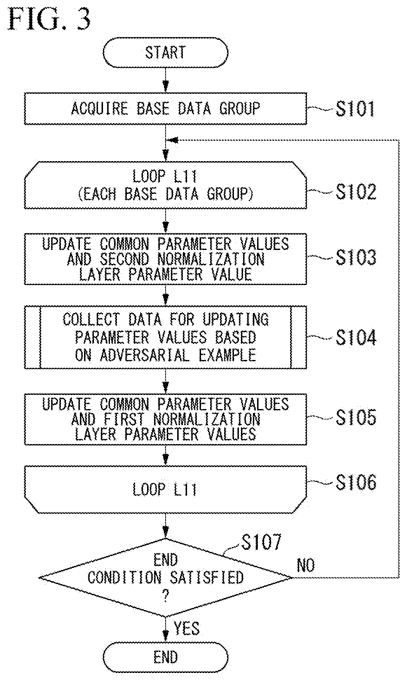

FIG. 3 shows an example of the procedure in which the processing portion 190 trains a neural network 201.

In the process shown in FIG. 3, the data acquisition portion 191 acquires a base data group (Step S101). In other words, the data acquisition portion 191 acquires base data organized into groups. The data acquisition portion 191 may acquire base data organized into groups in advance. Alternatively, the data acquisition portion 191 may acquire the base data and group them together into base data groups.

Next, the processing portion 190 starts loop L11, which processes each group of base data (Step S102). The base data group that is the target of processing in loop L11 is also referred to as the target base data group.

In the process of loop L11, the parameter updating portion 195 updates the parameter values of the common parts and the parameter value of the second normalization layer 230-2 using the target base data group (Step S103).

Next, the processing portion 190 collects data to update the parameter values of the common parts and the parameter values of the first normalization layer 230-1 (Step S104). The data for updating the parameter values of the common parts and the parameter values of the first normalization layer 230-1 are also referred to as data for updating parameter values based on an adversarial example.

Next, the parameter updating portion 195 updates the parameter values of the common parts and the parameter values of the first normalization layer 230-1 using the data obtained in Step S104 (Step S105).

Next, the processing portion 190 performs the termination of the loop L11 (Step S106).

Specifically, processing portion 190 determines whether or not the processing of the loop L11 has been performed for all the base data groups obtained in Step S101. In the second and subsequent iterations of loop L11, the processing portion 190 determines whether or not the processing of the loop L11 has been performed for all the base data groups obtained in Step S101 in that iteration.

If the processing portion 190 determines that there is a base data group for which the processing of the loop L11 has not yet been performed, the processing returns to Step S102. In this case, the processing portion 190 continues to perform the processing of the loop L11 for the base data group that has not been processed in loop L11.

On the other hand, if it is determined that the processing of the loop L11 has been performed for all the base data groups obtained in Step S101, the processing portion 190 ends the loop L11.

When the loop L11 is completed, the processing portion 190 determines whether the conditions for termination of learning have been met (Step S107). Various conditions can be used to complete the learning here. For example, the condition for completion of learning may be, but is not limited to, the condition that the processing from Step S102 to Step S107 has been repeated a predetermined number of times.

If the processing portion 190 determines that the conditions for termination of learning have not been met (Step S107: NO), the process returns to Step S102. In this case, the processing portion 190 repeats the updating of the parameter values of the neural network 201 by repeating the process of loop L11.

On the other hand, if the condition for completion of the learning is determined to be satisfied (Step S107: YES), the processing portion 190 completes the processing in FIG. 3.

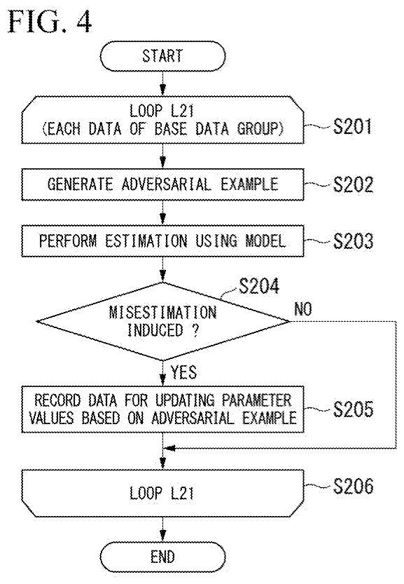

FIG. 4 is a diagram that shows an example of the procedure in which processing portion 190 collects data for updating parameter values based on the adversarial example. The processing portion 190 performs the processing of FIG. 4 in Step S104 of FIG. 3.

In the process shown in FIG. 4, the processing portion 190 starts a loop L21, which processes each base data included in the target base data group (Step S201). The base data that is subject to processing in loop L21 is also referred to as the target base data.

In the process of loop L21, the adversarial example acquisition portion 192 generates adversarial examples for the target base data (Step S202).

Next, the model execution portion 193 inputs the adversarial example obtained in Step S202 to the neural network 201 and performs estimation using the neural network 201 (Step S203).

Next, the error induction determination portion 194 determines whether the adversarial example for the target base data induces an error in the estimation obtained using the neural network 201 (Step S204).

If the error induction determination portion 194 determines that the adversarial example for the target base data has induced an error in the estimation obtained using the neural network 201 (Step S204: YES), the parameter updating portion 195 stores data for updating parameter values based on the adversarial example in the storage portion 180 (Step S205).

For example, when using a learning method based on the error of data calculated by each part of the neural network 201, such as the error back-propagation method, the parameter updating portion 195 may calculate the error in each part of the neural network 201 that is subject to updating of the parameter value and store it in the storage portion 180. In this case, the parameter updating portion 195 calculates the average value of the errors stored by the storage portion 180 for each part of the neural network 201 in Step S105 of FIG. 3, and updates the parameter values by applying the learning method to the calculated average value.

Next, the processing portion 190 performs the termination of the loop L21 (Step S206).

Specifically, the processing portion 190 determines whether or not the processing of the loop L21 has been performed for all the base data included in the target base data group. In the second and subsequent iterations of the loop L11 (FIG. 3), the processing portion 190 determines whether or not the processing of the loop L21 has been performed for all base data included in the target base data group in that iteration.

If the processing portion 190 determines that there is base data for which the processing of the loop L21 has not yet been performed, processing returns to Step S201. In this case, the processing portion 190 continues to perform the loop L21 for the base data that has not been processed in the loop L21.

On the other hand, if it is determined that the processing of the loop L21 has been performed for all the base data included in the target base data group, the processing portion 190 ends the loop L21.

When loop L21 is ended, the processing portion 190 ends the process in FIG. 4.

On the other hand, if the error induction determination portion 194 determines in Step S204 that the adversarial example for the target base data does not induce an error in the estimation using the neural network 201 (Step S204: NO), the process proceeds to Step S206. In this case, data is not recorded in Step S205. Therefore, the adversarial example for the target base data in this case is excluded from updating the parameter values of the common parts and the parameter value of the first normalization layer 230-1.

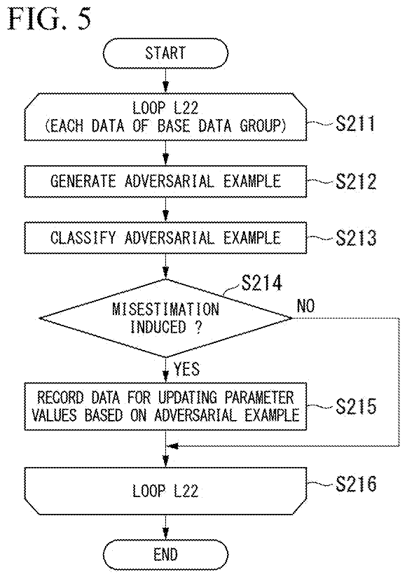

FIG. 5 shows an example of the procedure for the learning device 100 to collect data for updating parameter values based on adversarial examples when the neural network 201 is configured as categorical AI. The learning device 100 performs the process shown in FIG. 5 in Step S104 of FIG. 3.

The process shown in FIG. 5 corresponds to the example of the process shown in FIG. 4.

As described above, in the case of the neural network 201 being configured as categorical AI, the error induction determination portion 194 may determine that the input data is inducing an error in the estimate using the neural network 201 when the class estimation result output by the neural network 201 is different from the correct class associated with the input data to the neural network 201. FIG. 5 shows an example of the process in this case.

Step S211 to Step S212 in FIG. 5 are similar to Step S201 to Step S202 in FIG. 4. The process of loop L22 in FIG. 5 corresponds to the example of the process of loop L21 in FIG. 4.

After Step S212, the model execution portion 193 performs class classification of the adversarial examples by applying the adversarial examples for the target base data to the neural network 201 (Step S213). The process in Step S213 corresponds to an example of the process in Step S203 of FIG. 4. In the example in FIG. 5, the adversarial example obtained in Step S212 corresponds to the adversarial example for the target base data.

Next, the error induction determination portion 194 determines whether the adversarial example for the target base data is misclassified by the class classification using the neural network 201 (Step S214). Misclassification here is when the neural network 201 classifies the input adversarial example into a class different from the class that is considered the correct class for that adversarial example. Alternatively, misclassification here may be defined as the neural network 201 classifying an input adversarial example into a class that is considered the target class for that adversarial example.

The process in Step S214 corresponds to an example of the process in Step S204 of FIG. 4.

If the error induction determination portion 194 determines that the adversarial example for the target base data is misclassified by class classification using the neural network 201 (Step S214: YES), the process proceeds to Step S215. On the other hand, if the error induction determination portion 194 determines that the adversarial example for the target base data is not misclassified by class classification using neural network 201 (Step S214: NO), the process proceeds to Step S216.

Step S215 to Step S216 are similar to Step S205 to Step S206 in FIG. 4.

If loop L22 is terminated in Step S216, the processing portion 190 ends the process in FIG. 5.

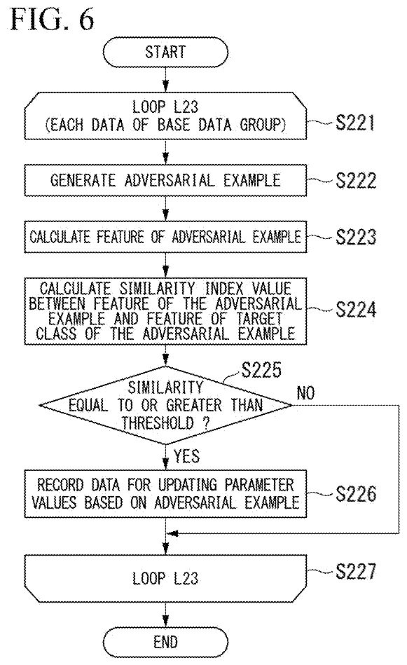

FIG. 6 shows an example of the procedure in which the learning device 100 collects data for updating parameter values based on adversarial examples when the neural network 201 is configured as feature-extraction AI. The learning device 100 performs the process shown in FIG. 6 in Step S104 of FIG. 3.

The process shown in FIG. 6 corresponds to the example of the process shown in FIG. 4.

As described above, in the case of the neural network 201 being configured as feature-extraction AI, the error induction determination portion 194 may determine that the input data is inducing an error in the estimate made using the neural network 201 when the class estimation result output by the neural network 201 indicates the target class of the adversarial example, which is the input data. FIG. 6 shows an example of the process in this case.

Steps S221 to S222 in FIG. 6 are similar to steps S201 to S202 in FIG. 4. The process of loop L23 in FIG. 6 corresponds to an example of the process of loop L21 in FIG. 4.

After Step S222, the model execution portion 193 calculates the feature of the adversarial example by applying the adversarial example to the target base data to the neural network 201 (Step S223). The process in Step S223 corresponds to an example of the process in Step S203 of FIG. 4. In the example in FIG. 6, the adversarial example obtained in Step S222 corresponds to the adversarial example for the target base data.

Next, the error induction determination portion 194 calculates the similarity between the feature of the adversarial example for the target base data and the feature associated with the target class of the adversarial example (Step S224).

Next, the error induction determination portion 194 determines whether the similarity calculated in Step S224 indicates that the similarity is equal to or greater than a predetermined threshold (Step S225). The process from Step S224 to Step S225 corresponds to an example of the process in Step S204 of FIG. 4.

If the error induction determination portion 194 determines that the similarity calculated in Step S224 indicates that the similarity is equal to or greater than a predetermined threshold (Step S225: YES), the process proceeds to Step S226. On the other hand, if the error induction determination portion 194 determines that the similarity calculated in Step S224 does not indicate that the similarity is equal to or greater than a predetermined threshold (Step S225: NO), the process proceeds to Step S227.

Steps S226 to S227 are similar to steps S205 to S206 in FIG. 4.

If loop L23 is terminated in Step S227, the processing portion 190 ends the process in FIG. 6.

As described above, the data acquisition portion 191 acquires a base data group, which is a group containing multiple data. The adversarial example acquisition portion 192 acquires an adversarial data group, which is a group containing multiple adversarial examples for data included in the base data group acquired by the data acquisition portion 191. The error induction determination portion 194 determines whether, when data is input to the neural network 201, the data induces an error in estimation using the neural network 201. The neural network 201 includes a partial network, a first normalization layer 230-1, and a second normalization layer 230-2, the first normalization layer 230-1 normalizing the data input to the first normalization layer 230-1 itself using the first average value and the first variance value, and the second normalization layer 230-2 normalizing the data input to the second normalization layer 230-2 itself using the second average value and the second variance value. The parameter updating portion 195 updates the parameter values of the partial network and the parameter values of the second normalization layer 230-2 using the base data group, and uses the adversarial examples determined to induce errors in estimation using the neural network 201 among the adversarial examples included in the adversarial data group to update the parameter values of the partial network and the parameter values of the first normalization layer 230-1.

The learning device 100 selects an adversarial example that induces an error in estimation using the neural network 201 and uses it to train the neural network 201. According to the learning device 100, in this regard, the accuracy of the adversarial examples can be taken into account when adversarial examples are used to train the neural network.

Here, an adversarial example, which is created by a small perturbation, can be viewed as an input intended to induce error in a neural network, and adversarial examples can be used to train a neural network in order to improve the accuracy of the neural network. In other words, an adversarial example could be used as training data to compensate for the weakness of the neural network by training the neural network to be able to make accurate predictions on error-prone data.

Here, an adversarial example that induces an error in estimation using neural network 201 can be viewed as input data with low accuracy in estimation using the neural network 201. It is expected that the neural network 201 can be trained efficiently by using this adversarial example.

On the other hand, an adversarial example that does not induce an error in estimation using the neural network 201 can be viewed as input data with relatively high accuracy in estimation using the neural network 201. If the adversarial examples used to train the neural network 201 include adversarial examples that do not induce errors in estimation using the neural network 201, the training of the neural network 201 will take longer, or the resulting accuracy of the neural network 201 may be relatively low.

If it is not determined whether the adversarial examples used as training data are capable of misleading the neural network in the training process, data that do not cause errors will be used for training. This reduces the effect of compensating for the weaknesses of neural nets, as described above.

In contrast, as described above, the learning device 100 selects an adversarial example that induces an error in estimation using the neural network 201 and uses it to train the neural network 201. According to the learning device 100, in this respect, it is expected that the time required to train the neural network 201 is relatively short, or that the accuracy of the neural network 201 obtained as a result of the training is relatively high.

The distribution of inputs to the neural network 201 is different for the base data and the adversarial example. The inclusion of a first normalization layer 230-1, which is associated with the input of the adversarial example, and a second normalization layer 230-2, which is associated with the input of the base data, in the neural network 201 is expected to allow the learning device 100 to train the neural network 201 relatively efficiently using these normalization layers.

The neural network 201 is also configured as categorical AI, which receives the input of data and performs class classification of that data. When the neural network 201 classified the input adversarial example into a class different from the class that is considered the correct class for that adversarial example, the error induction determination portion 194 determines that that adversarial example induces an error in estimation using the neural network 201.

Thus, according to the learning device 100, in the learning of a neural network configured as categorical AI, the above-mentioned effects of a relatively short time required for learning a neural network or a relatively high accuracy of a neural network obtained as a learning result are expected.

The neural network 201 is also configured as categorical AI, which receives the input of data and performs class classification of that data. When the neural network 201 classified the input adversarial example into a class that is considered the target class for that adversarial example, the error induction determination portion 194 determines that that adversarial example induces an error in estimation using that neural network.

Thus, according to the learning device 100, in the learning of a neural network configured as categorical AI, the above-mentioned effects of a relatively short time required for learning a neural network or a relatively high accuracy of a neural network obtained as a learning result are expected.

According to the learning device 100, if the target class of the adversarial example acquired by the adversarial example acquisition portion 192 is specified as a particular class, it is expected to be able to efficiently learn about class classification between the correct class and the target class.

The neural network 201 is configured as feature-extraction AI, which receives the input of data and extracts features of the data. The error induction determination portion 194 calculates the similarity between the features extracted by the neural network 201 for the input adversarial example and the features associated with the target class of the adversarial example and, when the calculated similarity indicates a similarity equal to or greater than a predetermined threshold value, determines that the adversarial example induces an error in the estimation using the neural network 201.

Thus, according to the learning device 100, in the learning of a neural network configured as feature-extraction AI, the above-mentioned effects of a relatively short time required for learning a neural network or a relatively high accuracy of a neural network obtained as a learning result are expected.

### Second Example Embodiment

The learning device may take into account the similarity of features to set the target class in an adversarial example. The second example embodiment explains this point.

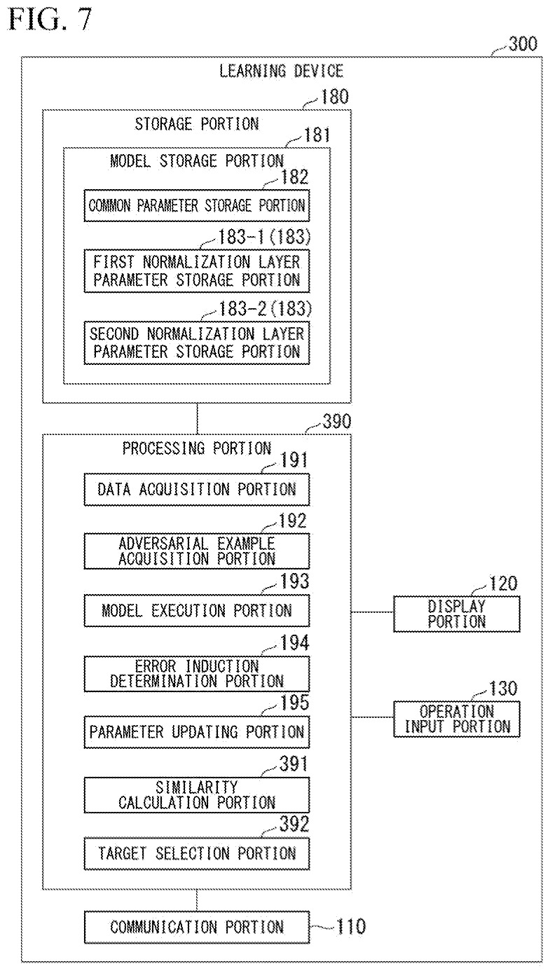

FIG. 7 is a diagram showing an example of the configuration of the learning device according to the second example embodiment. In the configuration shown in FIG. 7, a learning device 300 includes the communication portion 110, the display portion 120, the operation input portion 130, the storage portion 180, and the processing portion 390. The storage portion 180 includes the model storage portion 181. The model storage portion 181 includes a common parameter storage portion 182, the first normalization layer parameter storage portion 183-1, and the second normalization layer parameter storage portion 183-2. The processing portion 190 includes the data acquisition portion 191, the adversarial example acquisition portion 192, the model execution portion 193, an error induction determination portion 194, the parameter updating portion 195, a similarity calculation portion 391, and a target selection portion 392.

The same reference numerals (110, 120, 130, 180, 181, 182, 183-1, 183-2, 191, 192, 193, 194, 195) are attached to the parts of the learning device 300 shown in FIG. 7 that correspond to the parts of the learning device 100 shown in FIG. 1, with detailed explanations being omitted here.

In the learning device 300, the processing portion 390 includes the similarity calculation portion 391 and the target selection portion 392, in addition to the parts provided by the processing portion 190 of the learning device 100. In other respects, the learning device 300 is similar to the learning device 100.

The similarity calculation portion 391 calculates an index value indicating the similarity of two features. In particular, the similarity calculation portion 391 calculates an index value indicating the degree of similarity between a feature of the base data and a feature associated with the class that is considered a candidate target class when the adversarial example acquisition portion 192 generates an adversarial example for that base data.

The index used by the similarity calculation portion 391 is not limited to a specific one. The similarity calculation portion 391 may calculate an index value, such as cosine similarity, as an indicator of the similarity of the two features, such that the larger the index value, the more similar the two features are. Alternatively, the similarity calculation portion 391 may calculate an index value, such as the distance between two features in a feature space, that indicates that the smaller the index value, the more similar the two features are.

The index used by the similarity calculation portion 391 may be the same as or different from the index indicating the similarity of the features calculated by the error induction determination portion 194 when the neural network 201 is configured as feature-extraction AI. The similarity calculation portion 391 may be configured as part of the error induction determination portion 194.

The target selection portion 392 sets any of the classes other than the correct class of the base data as the target class based on the similarity between the feature of the base data and the features associated with the class other than the correct class of that base data.

For example, the similarity calculation portion 391 may calculate, for each class other than the correct class of the base data, an index indicating the similarity between the feature of the base data and the feature associated with that class. The target selection portion 392 may then set the target class to a class other than the correct class of the base data for which the index calculated by the target selection portion 392 indicates the highest feature similarity.

The adversarial example acquisition portion 192 generates an adversarial example for the base data using the class set by the target selection portion 392 as the target class.

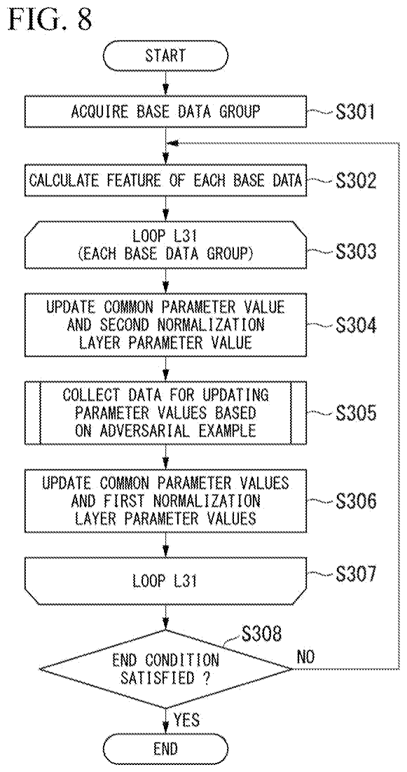

FIG. 8 shows an example of the procedure in which the processing portion 390 trains the neural network 201.

Step S301 in FIG. 8 is similar to Step S101 in FIG. 3.

After Step S301, the model execution portion 193 calculates the feature of each base data included in each base data group acquired in Step S301 (Step S302).

If the neural network 201 is configured as feature-extraction AI, the model execution portion 193 may input each base data to the neural network 201 and acquire the feature output by the neural network 201.

If the neural network 201 is configured as categorical AI, the model execution portion 193 may input each base data to the neural network 201 to acquire the feature that the neural network 201 calculates for classifying the base data.

Steps S303 through S308 are similar to steps S102 through S107 in FIG. 3, except for the processing in Step S305. The processing of loop L31 in FIG. 8 is similar to that of loop L11 in FIG. 3. The base data group that is the target of processing in loop L31 is also referred to as the target base data group.

If the processing portion 390 determines in Step S308 that the conditions for completion of the learning have not been met (Step S308: NO), the process returns to Step S302. In this case, the processing portion 390 updates the feature of each base data in Step S302 and repeats the process of the loop L31 to repeatedly update the parameter values of the neural network 201.

On the other hand, if the condition for completion of the learning is determined to be satisfied (Step S308: YES), the processing portion 390 completes the processing in FIG. 8.

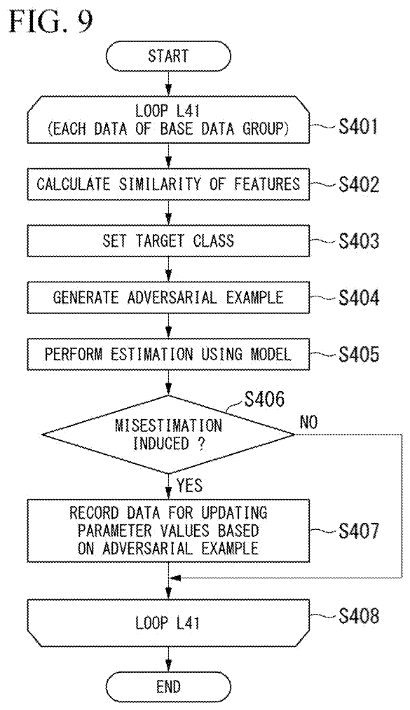

FIG. 9 is a diagram that shows an example of the procedure in which processing portion 390 collects data for updating parameter values based on the adversarial example.

The processing portion 390 performs the processing of FIG. 9 in Step S305 of FIG. 8.

Step S401 in FIG. 9 is similar to Step S201 in FIG. 4. The loop that the processing portion 390 initiates in Step S401 is referred to as loop L41. The base data that is the subject of processing in loop L41 is also referred to as the target base data.

In the process of loop L41, the similarity calculation portion 391 calculates, for each class other than the correct class of the target base data, an index indicating the similarity between the feature of the target base data and the feature associated with that class (Step S402).

Next, the target selection portion 392 sets any of the classes other than the correct class of the target base data as the target class based on the index value calculated by the similarity calculation portion 391 (Step S403).

Steps S404 through S408 are similar to steps S202 through S206 in FIG. 4.

In Step S404, the adversarial example acquisition portion 192 generates an adversarial example whose target class is the target class set by the target selection portion 392 in Step S403.

If loop L41 is terminated in Step S408, the processing portion 390 ends the process in FIG. 9.

As described above, the adversarial example acquisition portion 192, based on the similarity between the feature of base data, which is data included in the base data group, and the feature associated with a class other than the correct class of that base data, generates an adversarial example having any of the classes other than the correct class of that base data as its target class.

This allows the adversarial example acquisition portion 192 to generate adversarial examples with relatively high similarity between the features of the base data and the features associated with the target class, and the acquired adversarial examples are expected to be relatively more likely to induce errors in estimation using the neural network 201.

An adversarial example with a relatively high possibility of inducing an error in estimation using the neural network 201 can be viewed as input data by which the accuracy of estimation using the neural network 201 is relatively low. By learning the neural network 201 using this adversarial example, it is expected that the learning can be performed more efficiently.

### Third Example Embodiment

The third example embodiment describes an example of an estimation device during operation using a learned neural network and the configuration of the neural network.

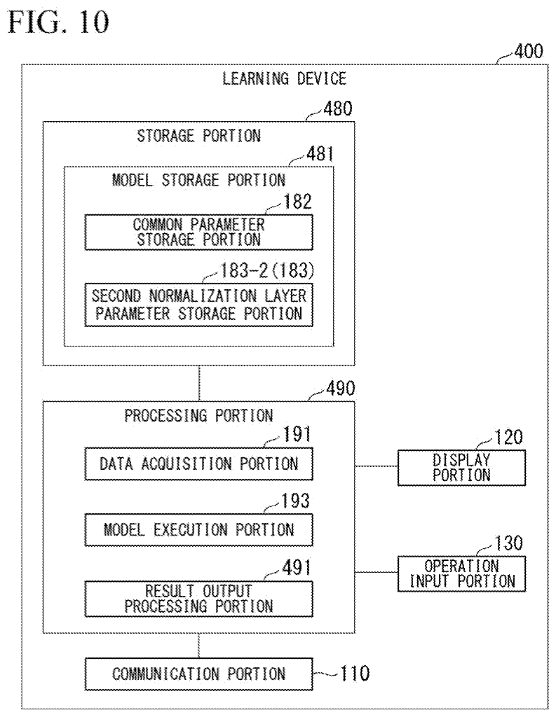

FIG. 10 is a diagram showing an example of the configuration of the estimating device according to the third example embodiment. In the configuration shown in FIG. 10, an estimation device 400 includes the communication portion 110, the display portion 120, the operation input portion 130, a storage portion 480, and a processing portion 490. The storage portion 480 is equipped with a model storage portion 481. The model storage portion 481 includes the common parameter storage portion 182 and the second normalization layer parameter storage portion 183-2. The processing portion 490 includes the data acquisition portion 191, the model execution portion 193, and a result output processing portion 491.

The same reference numerals (110, 120, 130, 182, 183-2, 191, 193) are attached to the parts of the estimation device 400 shown in FIG. 10 that have similar functions corresponding to the parts of the learning device 100 shown in FIG. 1, and detailed descriptions are omitted here.

In the estimation device 400, the storage portion 480 does not include the first normalization layer parameter storage portion 183-1, among the portions provided by the storage portion 180 of the learning device 100. In the estimation device 400, the processing portion 490 does not include the adversarial example acquisition portion 192, the error induction determination portion 194, and the parameter updating portion 195, among the parts provided by the processing portion 190 of the learning device 100, but includes the result output processing portion 491. Otherwise, the estimation device 400 is similar to the learning device 100.

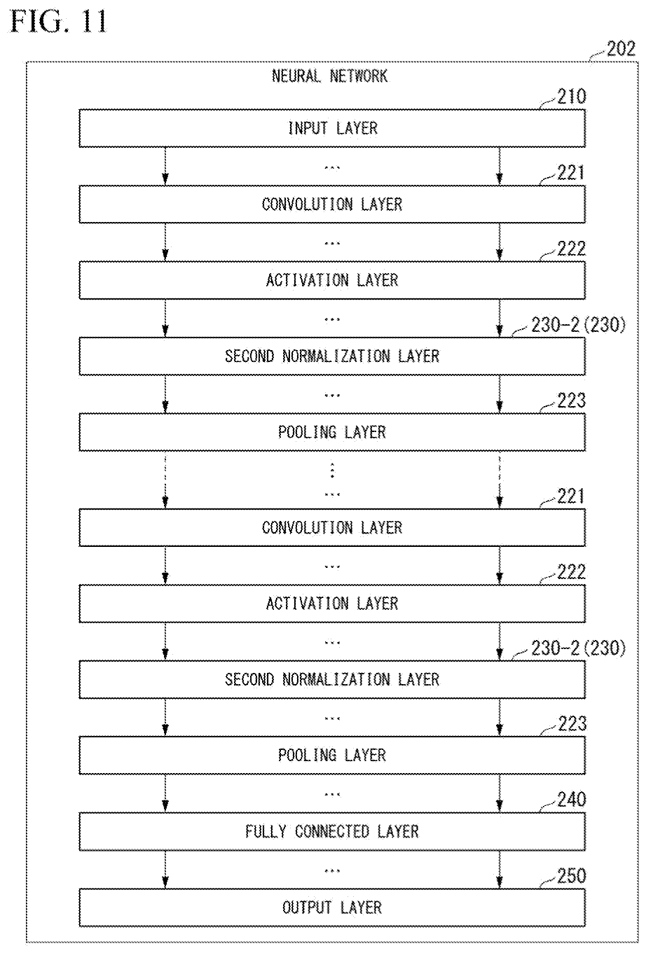

FIG. 11 is a diagram showing an example of a neural network stored by the model storage portion 481. The neural network 202 shown in FIG. 11 does not include the first normalization layer 230-1 among the parts that the neural network 201 shown in FIG. 2 includes. Otherwise, neural network 202 is similar to neural network 201.

The same reference numerals (210, 221, 222, 223, 230-2, 240, 250) are attached to the parts of the neural network 202 shown in FIG. 11 that have similar functions corresponding to the parts of the neural network 201 shown in FIG. 2, and detailed descriptions are omitted.

Since no learning is performed in the neural network 202, the first normalization layer 230-1, which is provided in the neural network 201 for learning in response to differences in the distribution of input data, is not provided.

The neural network 202 receives the input of data and outputs the results of estimation on the input data.

The neural network 202 may be configured as categorical AI or feature-extraction AI. When configured as categorical AI, the neural network 202 receives the input of data and outputs an estimate of the class of that data. When configured as feature-extraction AI, the neural network 202 receives the input of data and outputs the features of the data.

Since the neural network 202 is not equipped with the first normalization layer 230-1, the model storage portion 481 of the estimation device 400 is also not equipped with the first normalization layer parameter storage portion 183-1.

Since the estimation device 400 does not perform learning of neural networks, it is not equipped with the adversarial example acquisition portion 192, which acquires adversarial examples used as data for learning, the error induction determination portion 194, which selects adversarial examples as the target of parameter value updates, and the parameter updating portion 195, which updates parameter values, among the parts provided by the learning device 100.

In the estimation device 400, the data acquisition portion 191 acquires input data for the neural network 202.

The model execution portion 193 inputs the data acquired by the data acquisition portion 191 to the neural network 202 to obtain an estimation result using the neural network 202.

The result output processing portion 491 outputs the acquired estimation result. The method by which the result output processing portion 491 outputs the estimation result is not limited to a specific method. For example, the result output processing portion 491 may output the estimation result by displaying the estimation result on the display portion 120. Alternatively, the result output processing portion 491 may transmit the estimation result to other devices via the communication portion 110.

Alternatively, the neural network 201 shown in FIG. 2 may also be used during operation.

The estimation device 400 can be used for a variety of estimations. For example, the estimation device 400 may perform biometric authentication such as facial, fingerprint, or voiceprint recognition.

In this case, the estimation device 400 may attempt to classify the input data into any of the registered classes of persons, thereby authenticating the person indicated by the input data as any of the registered persons, or may fail to do so.

Alternatively, the estimation device 400 may extract the feature of the input data and compare the similarity with the feature of the data of the designated person to determine whether the person indicated by the input data and the designated person are the same person.

Alternatively, the estimation device 400 may be used in devices for applications other than biometrics, such as devices that make various predictions.

### Fourth Example Embodiment

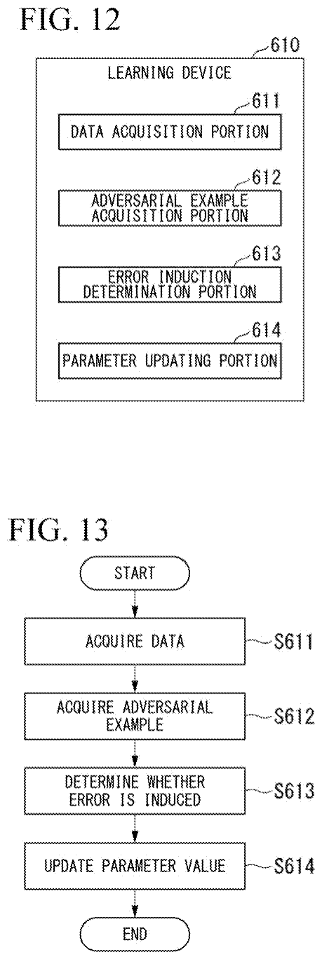

FIG. 12 is a diagram showing an example of the configuration of the learning device according to the fourth example embodiment. In the configuration shown in FIG. 12, a learning device 610 includes a data acquisition portion 611, an adversarial example acquisition portion 612, an error induction determination portion 613, and a parameter updating portion 614.

In such a configuration, the data acquisition portion 611 acquires a base data group, which is a group containing multiple data.

The adversarial example acquisition portion 612 acquires an adversarial data group, which is a group containing multiple adversarial examples for data included in the base data group acquired by the data acquisition portion 611.

The error induction determination portion 613 determines whether or not, when data is input to a neural network, the data induces an error in estimation using the neural network. The neural network here includes a partial network, a first normalization layer, and a second normalization layer. The first normalization layer normalizes the data input to the first normalization layer itself using the first average value and the first variance value. The second normalization layer normalizes the data input to the second normalization layer itself using the second average value and second variance value.

The parameter updating portion 614 updates the parameter values of the partial network and the parameter values of the second normalization layer using the base data group, and uses the adversarial examples determined to induce errors in estimation using the neural network among the adversarial examples included in the adversarial data group to update the parameter values of the partial network and the parameter values of the first normalization layer.

The data acquisition portion 611 is an example of a data acquisition means. The adversarial example acquisition portion 612 is an example of an adversarial example acquisition means. The error induction determination portion 613 is an example of an error induction determination means. The parameter updating portion 614 is an example of a parameter updating means.

The learning device 610 selects the adversarial examples that induce errors in estimation using the neural network and uses them to train the neural network. According to the learning device 610, in this regard, the accuracy of the adversarial examples can be taken into account when adversarial examples are used to train the neural network.

Here, an adversarial example that induces errors in estimation using a neural network can be viewed as input data for which the accuracy of estimation using that neural network is low. It is expected that this adversarial example can be used to train the neural network for efficient learning.

On the other hand, an adversarial example that does not induce errors in estimation using a neural network can be viewed as input data for which the accuracy of estimation using that neural network is relatively high. If the adversarial examples used to train the neural network include adversarial examples that do not induce errors in estimation using the neural network, the training of the neural network will take longer, or the accuracy of the resulting neural network will be relatively low.

In contrast, as described above, the learning device 610 selects adversarial examples that induce errors in estimation using the neural network and uses them to train the neural network. According to the learning device 610, it is expected that the time required to train a neural network is relatively short in this respect, or that the accuracy of the neural network obtained as a result of the training is relatively high.

The distribution of inputs to the neural network is different for the base data and the adversarial examples. The inclusion of a first normalization layer, which is associated with the input of adversarial examples, and a second normalization layer, which is associated with the input of the base data, in the neural network is expected to allow the learning device 610 to train the neural network relatively efficiently using these normalization layers.

The data acquisition portion 611 can be realized, for example, using functions such as the data acquisition portion 191 in FIG. 1. The adversarial example acquisition portion 612 can be realized, for example, using functions such as the adversarial example acquisition portion 192 in FIG. 1. The error induction determination portion 613 can be realized, for example, using functions such as the error induction determination portion 194 in FIG. 1. The parameter updating portion 614 can be realized, for example, using functions such as the parameter updating portion 195 in FIG. 1.

### Fifth Example Embodiment

FIG. 13 is a diagram showing an example of the processing procedure in the learning method according to the fifth example embodiment. The learning method shown in FIG. 16 includes acquiring data (Step S611), acquiring an adversarial example (Step S612), determining whether an error is induced (Step S613), and updating parameter values (Step S614).

In acquiring data (Step S611), a computer acquires a base data group, which is a group containing multiple pieces of data.

In acquiring an adversarial example (Step S612), a computer acquires an adversarial data group, which is a group containing multiple adversarial examples for the data included in the acquired base data group.

In determining whether or not an error is induced (Step S613), when data is input to a neural network that includes a partial network, a first normalization layer, and a second normalization layer, the first normalization layer normalizing data input to the first normalization layer itself using a first average value and a first variance value and the second normalization layer normalizing data input to the second normalization layer itself using a second average value and a second variance value, a computer determines whether that data induces an error in estimation using the neural network.

In updating parameter values (Step S614), a computer uses the base data group to update a parameter value of the partial network and a parameter value of the second normalization layer, and uses the adversarial example determined to induce an error in estimation using the neural network, among the adversarial examples included in the adversarial data group, to update the parameter value of the partial network and a parameter value of the first normalization layer.

In the learning method shown in FIG. 13, adversarial examples that induce errors in estimation using the neural network are selected and used to train the neural network. The learning method shown in FIG. 13 allows the accuracy of adversarial examples to be taken into account in this regard when adversarial examples are used to train a neural network.

Here, an adversarial example that induces an error in estimation using a neural network can be viewed as input data for which the accuracy of estimation using that neural network is low. By training a neural network using adversarial examples, it is expected that the training can be efficiently performed.

On the other hand, an adversarial example that does not induce errors in estimation using a neural network can be viewed as input data for which the accuracy of estimation using that neural network is relatively high. If the adversarial examples used to train the neural network include adversarial examples that do not induce errors in estimation using the neural network, the training of the neural network will take longer, or the accuracy of the resulting neural network will be relatively low.

In contrast, as described above, in the learning method shown in FIG. 13, adversarial examples that induce errors in estimation using the neural network are selected and used to train the neural network. According to the learning method shown in FIG. 13, it is expected that the time required to train a neural network is relatively short in this respect, or that the accuracy of the neural network obtained as a result of the training is relatively high.

The distribution of inputs to the neural network is different for the base data and the adversarial example. In the learning method shown in FIG. 13, the inclusion of a first normalization layer, which is associated with the input of adversarial examples, and a second normalization layer, which is associated with the input of the base data, in the neural network is expected to make training of a neural network relatively efficient using these normalization layers.

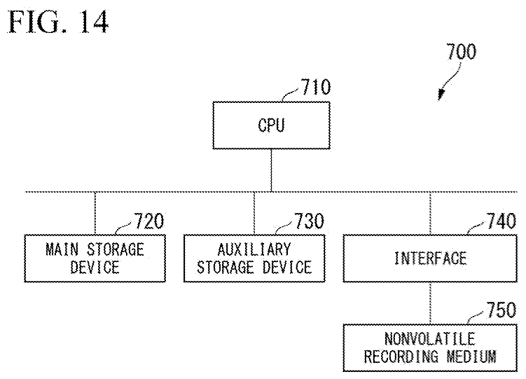

FIG. 14 is a schematic block diagram showing the configuration of a computer according to at least one example embodiment.

In the configuration shown in FIG. 14, a computer 700 includes a CPU 710, a main storage device 720, an auxiliary storage device 730, an interface 740, and a nonvolatile recording medium 750.

Any one or more of the above learning device 100, learning device 300, estimation device 400, and learning device 610, or any part thereof, may be implemented in the computer 700. In that case, the operations of each of the above-mentioned processing portions are stored in the auxiliary storage device 730 in the form of a program. The CPU 710 reads the program from the auxiliary storage device 730, deploys it in the main storage device 720, and executes the above processing according to the program. The CPU 710 also reserves a storage area in the main storage device 720 corresponding to each of the above-mentioned storage portions according to the program. Communication between each device and other devices is performed by the interface 740, which has a communication function and communicates according to the control of the CPU 710. The interface 740 also has a port for the nonvolatile recording medium 750, and reads information from and writes information to the nonvolatile recording medium 750.

When the learning device 100 is implemented in the computer 700, the operations of the processing portion 190 and the various parts thereof are stored in the auxiliary storage device 730 in the form of a program. The CPU 710 reads the program from the auxiliary storage device 730, deploys it in the main storage device 720, and executes the above processing according to the program.

The CPU 710 also reserves storage space in the main storage device 720 for the storage portion 180 and various parts thereof according to the program. Communication with other devices by the communication portion 110 is performed by the interface 740 having a communication function and operating according to the control of the CPU 710. The display of images by the display portion 120 is performed by the interface 740, which is equipped with a display portion and displays various images according to the control of the CPU 710. Reception of user operations by the operation input portion 130 is performed by the interface 740 being equipped with an input device and receiving user operations according to the control of the CPU 710.

When the learning device 300 is implemented in the computer 700, the operations of the processing portion 390 and the various parts thereof are stored in the auxiliary storage device 730 in the form of a program. The CPU 710 reads the program from the auxiliary storage device 730, deploys it in the main storage device 720, and executes the above processing according to the program.

The CPU 710 also reserves storage space in the main storage device 720 for the storage portion 180 and various parts thereof according to the program. Communication with other devices by the communication portion 110 is performed by the interface 740 having a communication function and operating according to the control of the CPU 710. The display of images by the display portion 120 is performed by the interface 740 being equipped with a display device and displaying various images according to the control of the CPU 710. Reception of user operations by the operation input portion 130 is performed by the interface 740 being equipped with an input device and receiving user operations according to the control of the CPU 710.

When the estimation device 400 is implemented in the computer 700, the operations of the processing portion 490 and the various parts thereof are stored in the auxiliary storage device 730 in the form of a program. The CPU 710 reads the program from the auxiliary storage device 730, deploys it in the main storage device 720, and executes the above processing according to the program.

The CPU 710 also reserves storage space in the main storage device 720 for the storage portion 480 and various parts thereof according to the program. Communication with other devices by the communication portion 110 is performed by the interface 740 having a communication function and operating according to the control of the CPU 710. The display of images by the display portion 120 is performed by the interface 740 being equipped with a display device and displaying various images according to the control of the CPU 710. Reception of user operations by the operation input portion 130 is performed by the interface 740 being equipped with an input device and receiving user operations according to the control of the CPU 710.

When the learning device 610 is implemented in the computer 700, the operations of the data acquisition portion 611, the adversarial example acquisition portion 612, the error induction determination portion 613, and the parameter updating portion 614 are stored in the auxiliary storage device 730 in the form of programs. The CPU 710 reads the program from the auxiliary storage device 730, deploys it in the main storage device 720, and executes the above processing according to the program.

The CPU 710 also allocates storage space in the main storage device 720 for processing by the learning device 610 according to the program. Communication between the learning device 610 and other devices is performed by the interface 740 having a communication function and operating according to the control of the CPU 710. The interaction between the learning device 610 and the user is performed by the interface 740 having an input device and an output device, presenting information to the user with the output device and receiving user operations with the input device according to the control of the CPU 710.

Any one or more of the above programs may be recorded on the nonvolatile recording medium 750. In this case, the interface 740 may read the programs from the nonvolatile recording medium 750. The CPU 710 may then directly execute the program read by the interface 740, or it may be stored once in the main storage device 720 or the auxiliary storage device 730 and then executed.

A program for executing all or some of the processes performed by the learning device 100, the learning device 300, the estimation device 400, and the learning device 610 may be recorded on a computer-readable recording medium, and by reading the program recorded on this recording medium into a computer and executing it, the processing of each portion may be performed. The term “computer system” here shall include an operating system (OS) and hardware such as peripheral devices.

In addition, “computer-readable recording medium” means a portable medium such as a flexible disk, magneto-optical disk, ROM (Read Only Memory), CD-ROM (Compact Disc Read Only Memory), or other storage device such as a hard disk built into a computer system. The aforementioned program may be used to realize some of the aforementioned functions, and may also be used to realize the aforementioned functions in combination with a program already recorded in the computer system.

While preferred example embodiments of the disclosure have been described and illustrated above, it should be understood that these are exemplary of the disclosure and are not to be considered as limiting. Additions, omissions, substitutions, and other modifications can be made without departing from the spirit or scope of the present disclosure. Accordingly, the disclosure is not to be considered as being limited by the foregoing description, and is only limited by the scope of the appended claims.

What is claimed is:

1. A learning device comprising:
at least one memory configured to store instructions; and
at least one processor configured to execute the instructions to:
acquire a base data group, which is a group including a plurality of data;
acquire an adversarial data group, which is a group including a plurality of adversarial examples with respect to the data included in the acquired base data group;
determine, when data is input to a neural network that includes a partial network, a first normalization layer, and a second normalization layer, the first normalization layer normalizing data input to the first normalization layer itself using a first average value and a first variance value and the second normalization layer normalizing data input to the second normalization layer itself using a second average value and a second variance value, whether that data induces an error in estimation using the neural network; and
use the base data group to update a parameter value of the partial network and a parameter value of the second normalization layer, and use the adversarial example determined to induce an error in estimation using the neural network, among the adversarial examples included in the adversarial data group, to update the parameter value of the partial network and a parameter value of the first normalization layer.

2. The learning device according to claim 1, wherein the neural network is configured to receive input of data and classifies the data into classes, and
the at least one processor is configured to execute the instructions to determine that an input adversarial example induces an error in estimation using the neural network if the neural network classifies the input adversarial example into a class different from the class that is considered the correct class for that adversarial example.

3. The learning device according to claim 1, wherein the neural network is configured to receive input of data and classifies the data into classes, and
the at least one processor is configured to execute the instructions to determine that an input adversarial example induces an error in estimation using the neural network if the neural network classifies the input adversarial example into a class that is considered the target class of that adversarial example.

4. The learning device according to claim 1, wherein the neural network is configured to receive input of data and extracts features of the data, and
the at least one processor is configured to execute the instructions to calculate the similarity between the features extracted by the neural network for the input adversarial example and the features associated with the target class of the adversarial example and, when the calculated similarity indicates a similarity equal to or greater than a predetermined threshold value, determine that the adversarial example induces an error in the estimation using the neural network.

5. The learning device according to claim 1, wherein the at least one processor is configured to execute the instructions to, based on the similarity between the feature of base data, which is data included in the base data group, and the feature associated with a class other than the correct class of that base data, generate an adversarial example having any of the classes other than the correct class of that base data as its target class.

6. A learning method executed by a computer, comprising:
acquiring a base data group, which is a group including a plurality of data;
acquiring an adversarial data group, which is a group including a plurality of adversarial examples with respect to the data included in the acquired base data group;
determining, when data is input to a neural network that includes a partial network, a first normalization layer, and a second normalization layer, the first normalization layer normalizing data input to the first normalization layer itself using a first average value and a first variance value and the second normalization layer normalizing data input to the second normalization layer itself using a second average value and a second variance value, whether that data induces an error in estimation using the neural network; and
using the base data group to update a parameter value of the partial network and a parameter value of the second normalization layer, and using the adversarial example determined to induce an error in estimation using the neural network, among the adversarial examples included in the adversarial data group, to update the parameter value of the partial network and a parameter value of the first normalization layer.

7. A non-transitory storage medium storing a program for causing a computer to execute:
acquiring a base data group, which is a group including a plurality of data;
acquiring an adversarial data group, which is a group including a plurality of adversarial examples with respect to the data included in the acquired base data group;
determining, when data is input to a neural network that includes a partial network, a first normalization layer, and a second normalization layer, the first normalization layer normalizing data input to the first normalization layer itself using a first average value and a first variance value and the second normalization layer normalizing data input to the second normalization layer itself using a second average value and a second variance value, whether that data induces an error in estimation using the neural network; and
using the base data group to update a parameter value of the partial network and a parameter value of the second normalization layer, and using the adversarial example determined to induce an error in estimation using the neural network, among the adversarial examples included in the adversarial data group, to update the parameter value of the partial network and a parameter value of the first normalization layer.
